(19) United States
(12) Patent Application Publication
(10) Pub. No.: US 2010/0288963 A1
(43) Pub. Date: Nov. 18, 2010

(54) Modified silica particles and dirt repellent polymer compositions comprising them

(75) Inventors: Valentina Mitina, Tarrytown, NY (US); Wolfgang Peter, Neuenburg am Rhein (DE)

Correspondence Address: BASF Corporation;Patent Department, 500 White Plains Road, P.O. Box 2005, Tarrytown, NY, 10591, US

(73) Assignee: BASF SE, Ludwigshafen (DE)

(21) Appl. No.: 12/724,772

(22) Filed: Mar. 16, 2010

Related U.S. Application Data
(60) Provisional application No. 61/210,370, filed on Mar. 18, 2009.

(51) Int. Cl. C08K 5/5415; C07F 7/04; D06M 15/19; C04B 14/04

(52) U.S. Cl. 252/8.62; 556/436; 524/265; 106/481

(57) ABSTRACT

The surfaces of nano silica particles are modified with siloxane substituents containing aldehyde functional groups providing particles which are readily incorporated into compositions, such as polymeric coating compositions, to improve scratch resistance, dirt pick-up resistance, anti-adhesion properties and while maintaining excellent film forming properties. Provided are the novel silica particles, a simple economic process for their preparation and dirt repellent coatings and polymeric molding compositions containing them.

This application claims benefit under 35 USC 119(e) of U.S. provisional application No. 61/210,370, filed Mar. 18, 2009.

The invention provides surface modified silica particles characterized by the bonding of the particle surface to siloxane substituents containing aldehyde functional groups, methods for their preparation and polymer compositions incorporating them, such as coating compositions and molding compositions which exhibit anti-adhesion and dirt repellency properties.

Improving the surface qualities and durability of substrates continues to be an ongoing concern. The surfaces of articles made from wood, concrete, synthetic and natural polymers, glass, ceramics, metals etc often need to be protected from a variety of environmental agents such as water, sunlight, pollutants etc. Many metal surfaces are subject to corrosion, some polymeric surfaces are easily scratched or stained and so forth. In addition, the demands being placed on the surfaces of many everyday articles are increasing, for example, many well known commercial products and methods are available to make surfaces water repellant, water absorptive, oil repellent, stain resistant, dirt resistant, anti-microbial, anti adhesive, anti-static, anti-fog, anti-scratch are commercial products.

Surface characteristics can be altered or enhanced in a number of ways, for example, by modifying the bulk material which makes up the substrate or by applying a coating to its surface. Co-pending U.S. patent application Ser. No. 12/321,542, incorporated herein in its entirety by reference, discloses a dirt resistant coating comprising of a network of metal oxides particles.

Polysiloxanes, polymers consisting of repeating silicon-oxygen atoms in the backbone, have been used as both a significant part of a coating binder and as a polymer additive to improve, among other properties, the scratch resistance of plastic articles. For example, polysiloxane binders have been developed for coatings to improve the chemical and scratch resistance of polymeric substrates such as polycarbonate and acrylic glazing, acrylic lenses and the like. Similar polysiloxanes have also been used as additives to binder systems and incorporated as additives to bulk polymer compositions to improve the scratch resistance and anti-adhesion properties of films and molded articles produced therefrom.

U.S. Pat. No. 4,113,665, incorporated herein in its entirety by reference discloses a process for making chemically resistant coatings by reacting, in an acid medium, trialkoxysilanes and silicone intermediates.

U.S. Pat. No. 4,812,518, incorporated herein in its entirety by reference, discloses polysiloxanes containing polyester groups for, paints and molding compositions to provide an anti-adhesion quality. However, to achieve an adequate effect requires a high additive concentration and other paint properties may be adversely affected.

U.S. Pat. No. 5,275,645 incorporated herein in its entirety by reference, discloses a protective polysiloxane coating made by polymerizing oxysilanes having side groups selected from hydrogen, alkyl, aryl, hydroxyalkyl, alkoxyalkyl and hydroxyalkoxyalkyl containing up to six carbon atoms, where there are at least two hydrolyzable side groups.

U.S. Pat. No. 6,054,534, incorporated herein in its entirety by reference, discloses silicone poly(meth)acrylates, prepared from alkoxysiloxanes and hydroxy-functional poly(meth)acrylates, which may be used as additives to coating compositions. However, the polymer segments are linked via a hydrolytically unstable Si—O—C bond, and the anti-adhesion effects are not maintained over a prolonged period of time.

JP-11189701 describes a curable, two-component composition possessing anti-adhesion properties comprising a crosslinker and a branched polymer comprising a base molecule to which the polydimethylsiloxane side chains are attached via a Si—C bond.

U.S. Pat. No. 7,122,599, incorporated herein in its entirety by reference, discloses coating compositions and polymeric molding compounds having anti-adhesion and dirt repellency properties containing as an additive a branched polymer which comprises a polymeric base molecule and polydiorganosiloxane side chains which are bonded covalently to the base molecule via Si—C bonds.

Fillers, such as colloidal silica, have also been used in polymeric coatings and molding compositions, often along with siloxane polymers, to improve properties such as scratch resistance and anti-adhesion. Aqueous colloidal silica dispersions generally have a particle size in the range of 5 to 150 millimicrons in diameter. Dispersants can be used to keep the filler particles adequately dispersed in the composition until curing can take place.

U.S. Pat. No. 5,719,220, incorporated herein in its entirety by reference, discloses a highly filled, curable composition comprising (A) an addition polymerizable organic liquid which on curing forms a solid polymer, (B) 20 to 80% by volume of a finely divided particulate inorganic and (C) 0.05 to 0.5% by weight of a polydimethylsiloxane which produce molded articles with improved resistance to minor scratching.

U.S. Pat. No. 4,027,073, incorporated herein in its entirety by reference, discloses an unpigmented, anti-scratch coating comprising a dispersion of colloidal silica in an alcohol-water solution of the partial condensate of a silanol of the formula RSi(OH)₃, wherein R is an alkyl radical of 1 to 3 carbon atoms, vinyl, 3,3,3-trifluoropropyl, gamma-glycidoxypropyl or gamma-methacryloxypropyl, wherein in at least 70 weight percent of the silanol, R is methyl.

In many cases, compositions with better stability and performance characteristics have been obtained by using surface modified particles, such as surface modified silica particles. Surfaces can be modified, for example, by bonding alkyl groups to the particle to decrease aggregation or by incorporating organic moieties that can react with other active components, monomers, synthetic polymers, biopolymers etc.

U.S. Pat. No. 7,144,930, incorporated herein in its entirety by reference, discloses structurally modified silicas with 3-methacryloxypropylsilyl and/or glycidyloxypropylsilyl groups on the surface prepared by mixing the silicas with the silane and heat-treating, destructuring and grinding the mixture, for use in radiation-curing coatings.

US Pub Pat Appl No 2007/0282122 incorporated herein in its entirety by reference, discloses organosilane-modified nanoparticles of silica, having a particle size of no more than 1 micron, in which the organosilane resides throughout the entire volume of the nanoparticles, not just at the surface, the prepared by hydrolyzing an alkali silicate under acidic conditions to obtain a silicic acid dispersion, followed by adding an organosilane having hydroxyl and/or hydrolyzable groups to the dispersion under acid conditions; and then raising the pH of the dispersion to at least eight to form the nanoparticles.

The modified silicas of 2007/0282122 contain reactive functionality and can be used as building blocks for hybrid systems where organic materials are bound to the silica particle. Polymerization with additional silanes, particularly siloxanes will provide hybrid polymer systems which comprise organic and inorganic sections.

US Pub Pat Appl No 2008/0058489, incorporated herein in its entirety by reference, discloses aqueous silane nanocomposite compositions based on the reaction at least of the following components: (i) a glycidyloxypropylalkoxysilane, (ii) an aqueous silica sol having an SiO₂ content of >20% by weight, (iii) an organic acid hydrolysis catalyst, and (iv) n-propyl zirconate, butyl titanate or titanium acetylacetonate as crosslinker and the use thereof as a composition for scratch resistant coatings. In the compositions of 2008/0058489, the organo silane modifyer is bound to the surface of an existing nano-particle and the attached epoxy groups can be used as reactive sites, if desired, in the preparation of hybrid, polymeric binders.

It has now been found that modifying the surface of silica nano-particles with aldehyde containing silanes provides a hybrid organosiloxy-silica particle which can be readily added to polymer compositions, even at relatively low concentrations, to improve scratch resistance and anti adhesion properties. In particular, addition of the particles to water based paints improves the dirt pick-up resistance of the dried coating surface without detracting from the other properties of the coating. While the inventive particles are capable of being reacted into hybrid polymers if desired, they can be added in the same manner as other fillers. Further, whether the particles are reacted into a polymer or not, compositions comprising the inventive particles retain virtually all of their anti-adhesion and dirt-repellency effects over a long period of time (e.g. several years) under outdoor weathering conditions and over a plurality of cleaning cycles.

### SUMMARY OF THE INVENTION

The invention provides structurally modified silicas characterized by aldehyde groups fixed, e.g., bound, on the surface prepared by reacting i) an aqueous dispersion of nano-particles of silica or silica mixed or coated with alumina or other inorganic materials, and ii) an oxysilane substituted at least once on silicon by an alkyl group containing aldehyde functionality or an oxygen functionality readily converted to an aldehyde, and when the oxysilane is not substituted by aldehyde, conversion of the oxygen functionality to an aldehyde.

Also provided are polymer compositions containing the modified silicas, the surfaces of the compositions exhibiting improved dirt repellence, scratch-resistance and anti-adhesion properties. For example, the particles of the invention are readily incorporated into water based paints, which can be applied to a variety of substrates, including organic polymers, wood, paper, metal, concrete, plaster, brick, stone, glass, ceramics, textiles etc, to protect, alter or improve the surface properties thereof. In particular, aqueous coatings systems with excellent dirt repellency and smooth surface characteristics are obtained using the particles of the invention.

### DESCRIPTION OF THE INVENTION

The particles of the invention have surfaces modified by at least one aldehyde containing oxysilane group, often more than one aldehyde containing oxysilane group, which can represented schematically as

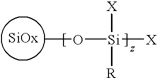

wherein

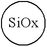

represents a silica particle with the circle representing the surface of the particle, wherein the silica particle is typically predominately SiO₂, but the silica may be mixed or coated with silica suboxides, alumina, titanium oxide, zinc oxide or other inorganic materials,
Z is a number from 1-30, typically from 1-6
R is an aldehyde containing alkyl group of 1-12 carbon atoms which may be substituted by hydroxy, alkoxy or acyl groups, or an aldehyde containing alkyl group of 4-12 carbon atoms which is interrupted by 1 to 3 oxygen atoms which may be substituted by hydroxy, alkoxy or acyl groups,
and X is hydroxy, alkoxy, a group R, or a group

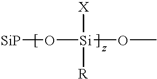

wherein SiP is the surface of the same or different silica particle, typically the same particle.

The oxy silane is typically believed to be bound to the silica particles through reaction at Si—O or Si—OH at the surface of the particle.

The modified silica particles are prepared by

1) the reaction under acidic conditions and typically in water, of
i) a nano-silica in the form of an aqueous silica dispersion having an SiO₂ content of 20% by weight or more, or mixture of silica with alumina or other inorganics, and
ii) an oxysilane substituted at least once on silicon by an alkyl group containing aldehyde functionality or an oxygen functionality readily converted to an aldehyde, and,
2) when the oxysilane is not substituted by aldehyde, conversion of the oxygen functionality to an aldehyde. No isolation of any intermediates is required.

Commercial, aqueous dispersions of silica or silica/alumina particles, such as silica sols, can be conveniently used or aqueous dispersions can be readily prepared using commercial, dry silica particles. Of course, instead of commercial silica, nano-silica particles can be prepared using any of the well known procedures, such as a sol process or pyrogenically prepared by flame hydrolysis of SiCl₄ as in U.S. Pat. No. 7,144,930.

Typically, the silica particle consists essentially of SiO₂, that is, the particle consists mainly of silicon dioxide or silicon oxides wherein the ratio of Si to 0 is between about 1.8 and about 2.2 and where small amounts of other materials may be present but not in amounts that affect the characteristics of the particle.

As in U.S. Pat. No. 4,027,073, already incorporated by reference, the silica component used in the reaction may be an aqueous colloidal silica dispersion wherein the silica generally has a particle size in the range of 5 to 150 nanometers, for example, 10 to 50 nanometers in diameter which are commercially available as both acidic and basic hydrosols. The silica used to prepare the instant modified particles is distinguished from other water dispersible forms of SiO₂, such as nonparticulate polysilicic acid or alkali metal silicate solutions, which are not operative in the practice of the present invention.

Also commercially available for use in the above reaction are silica sols that contain not only amorphous, aqueous SiO₂ particles but also further sol-gel-forming, aqueous element oxides, such as aluminum oxides, or silicon/aluminum oxides having an average particle size of from 40 to 400 nm.

The substituted oxysilane specie that reacts with the silica in the above reaction typically has the formula

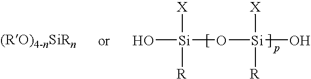

wherein
n is 1, 2 or 3, typically n is 2 or 3, very often n is 3; p can be almost any number but is generally from 1 to about 30, typically from 1 to about 5;
R′ is H or C₁₋₁₂ alkyl, for example C₁₋₄ alkyl and
R is C₁₋₆ aldehyde, C₁₋₆ alkyl substituted by hydroxyl, alkoxy, alkylcarboxy, oxirane, i.e., epoxy, or C₁₋₆ alkyl substituted by a group OR″ wherein R″ is C₂₋₆ aldehyde or C₁₋₆ alkyl substituted by hydroxyl, alkyloxy, alkylcarboxy, or oxirane
X is as defined above.

Although the silane species that reacts with the silica particle is typically as represented above, oxy silanes undergo a variety of transformations under the reaction conditions, as described below. Thus, while the silane that undergoes the reaction at the silica surface is any of those as described above, the chemist can achieve any and all of the same end results by choosing as the oxysilane reagent for the reaction a compound of the formula:

(R′O)₄₋ₙSiRₙ

wherein R, R′ and n are as described above. For greater ease in handling the reactants, in one embodiment of the invention the same end results are achieved using the oxysilane wherein R′ is C₁₋₄ alkyl. More than one oxy silane may be used.

The oxy silane is typically believed to bind to the silica particles through reaction at Si—O or Si—OH at the surface of the particle. For example, the reaction of silica particle and a trimethoxy silane can be represented as follows, the silyl ether bonds being readily hydrolyzed under a variety of conditions, especially in an aqueous acidic environment:

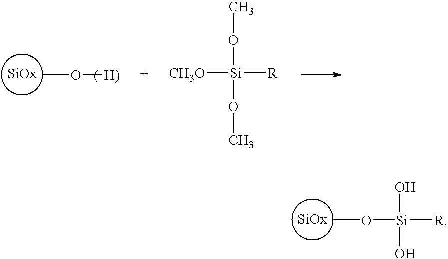

The above scheme represents an idealized version of the reaction between a silica surface and a trimethoxy silane. However, many oxysilanes useful in the invention not only readily hydrolyze, but polymerize as well, for example:

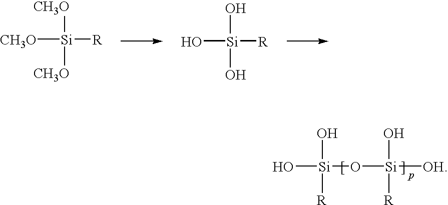

Crosslinking can also occur by further reaction of the liberated hydroxy groups, although higher temperatures are typically required for extensive crosslinking. Thus, siloxanes of the invention with the formula

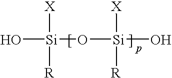

are readily prepared from silanes of the formula (R′O)₄₋ₙSiRₙ either before mixing with the silica particles or in situ upon addition to a suspension of the silica particles to generate the structures:

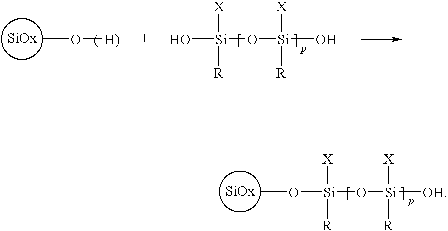

In one embodiment of the invention, a monomeric oxysilane is transformed into a polysiloxane, or a alkoxy silane is transformed into a hydroxy silane, prior to mixing with the silica.

Silica with surfaces modified by polymeric oxy silanes as in the above scheme are also produced by forming a monomer addition product followed by addition to the oxysilane moiety further oxy silanes as follows:

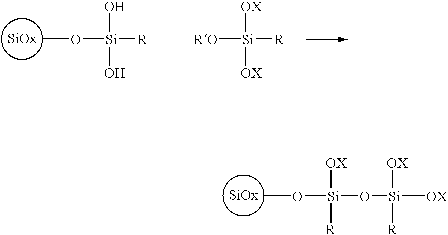

Additional reactions lead to longer oxy silane chains.

In another embodiment of the invention, a monomeric oxysilane is added to a dispersion of silica and transformed into a polysiloxane or hydroxy silane in the reaction mixture.

Typically, a chain length of 1 to 6 siloxane units is encountered in the invention. Branching or crosslinking of siloxy groups can occur at any stage of the reaction process as well. As suggested above, heating generates greater amounts of crosslinking.

Also, there is more than one reactive site on a silica particle and reaction of more than one oxy silane group with the silica surface is possible and frequently occurs. Often, by design, e.g., adding two or more different silane reagents, or by reason of the polymerization reactions, silanes of various and diverse formulae may be attached to a single silica surface.

In reactions which form the modified silicas of the invention, it has been found that oxysilanes of the formula

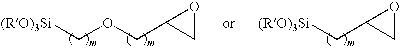

wherein each m is independently a number 1 to 6, are very useful starting materials. The epoxy group can be converted into a diol or aldehyde by simple transformations after reaction with the silica particle or in an alternate embodiment, before reaction with the silica particle to generate, for example, compounds such as

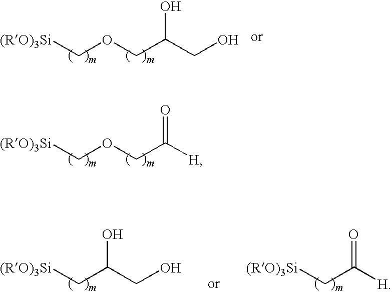

Of course, conversion to a polymeric oxy silane can also occur at any stage of the process.

Thus, the commercial 3-glycidyloxypropyltrimethoxysilane can be used to generate the aldehyde modified surfaces of the invention according to the following idealized reaction scheme:

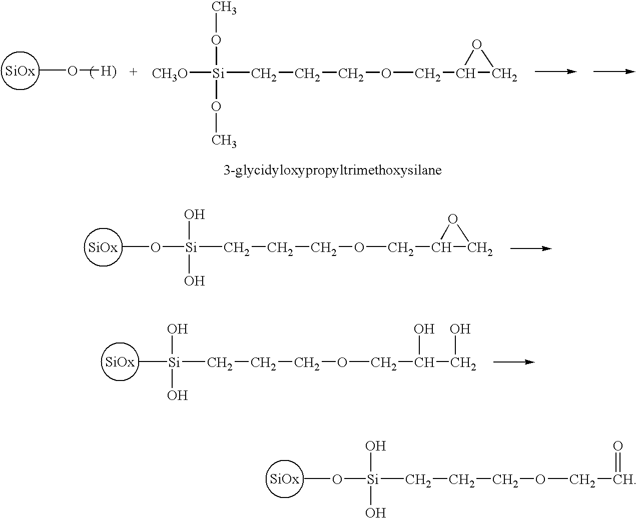

As stated above, the chemist can choose to convert the epoxide to the diol or aldehyde prior to reaction with the silica surface. Oxy silane polymerization can also occur with the epoxide, diol or aldehyde. The exact nature of the final silica particle, number of groups attached to the surface, the amount of siloxane polymerization and crosslinking etc, will be determined largely by the amount of oxy silane added and the selection of appropriate reaction sequences and conditions. However, given the many reactions available to the oxysilane, mixtures of particles with some variation in exact composition is expected and these mixtures can be used in forming the polymer compositions of the invention.

All of the reactions can be run in water or an organic solvent or mixtures of water with an organic solvent. Water is an excellent choice for a solvent as all of the reactions can be run in water without isolating any intermediates or changing solvents. For example, while conversion of the epoxide to the diol can be accomplished in any known manner, it occurs conveniently under aqueous conditions, such as acidic aqueous conditions, and the thus formed diol is efficiently converted to the aldehyde with periodate after neutralization of the acid. Both reactions can be run sequentially in the same vessel, using water as the solvent. Periodic acid can be used instead of periodate.

The reaction of silica with epoxy silanes, such as 3-glycidyloxypropyltrimethoxysilane, is also conveniently run in water with excellent results. As noted above, silica particles modified with glycidyloxypropylalkoxysilane by reaction in alcoholic or other organic solvents are known. However, particles prepared according to the invention by reacting glycidyloxypropylalkoxysilane with nano-silica in water under acidic conditions, as shown in the examples, when added to an aqueous coating system provide films of higher quality than similar particles prepared using an organic solvent. For example, less aggregation and better dispersion is seen with particles of the instant invention as evidenced by much smoother surfaces as compared to coatings containing similar particles prepared in an organic solvent. This improvement in film quality is also seen in the excellent dirt-pickup resistance when using the particles prepared in water according to this invention.

One embodiment of the invention therefore relates to an aqueous coating formulation containing the reaction product from the aqueous reaction of silica with glycidyloxy-alkyl-alkoxysilane, particularly glycidyloxypropylalkoxysilane. A further embodiment provides an aqueous coating formulation containing a mixture of the reaction product from the aqueous reaction of silica with glycidyloxy-alkyl-alkoxysilane, particularly glycidyloxypropylalkoxysilane, with products obtained from further reaction with hydroxide and periodate, i.e., the diol and aldehydes above.

It is obvious from the reactions above that alcohols are generated during the course of the reaction when alkoxysilanes are used. There may also be some alcohol present in the dispersion of nano-silica used as starting material. Given the fact that the presence of some alcohol is often inevitable, the addition of small amounts of an alcohol to the reactions run in water, e.g., less than about 10% or more typically less than about 5% by weight based on the amount of water used, is assumed to have little effect on the process. However, there is generally no reason to add an alcoholic co-solvent.

In one embodiment, the modified silica particles containing aldehyde groups are obtained with excellent results by

1) mixing an aqueous silica sol having an SiO 2 content of >20% by weight aqueous dispersions nano-silica particles with at least one oxy silane of the formula

(R′O)₃SiR or (R′O)₂SiR₂

wherein
R′ is C₁₋₁₂ alkyl, for example C₁₋₄ alkyl and

### R is

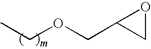

in particular

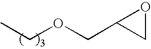

in an acidic aqueous environment, e.g., the solvent consists essentially or entirely of water at a pH below 7, followed by
2) neutralization of the acid, for example by addition of sodium hydroxide, and addition of periodate, for example sodium periodate. The hydroxide and periodate can be added as solids or in solution, particularly a solution in water. Other counterions for hydroxide and periodate can also be used, for example, lithium or potassium hydroxides are common.

Temperatures for each process can range from 0° C. to 100° C., 10° C. to 100° C. typically from about 20° C. or 30° C. to about 70° C., 90° C. or 100° C. The components of the reaction are generally mixed to together at temperatures close to room temperature, for example, from about 20° C. to about 30° C. before applying any desired heat.

Step 1 is generally run to yield the diol containing silica/silane addition product, that is both silane addition and hydrolysis of the epoxide occurs. For best results, this is carried out by first reacting the silane and silica in the presence of a weak acid or buffer, for example an organic acid such as acetic acid or a sodium acetate or other common buffer, at a pH typically between 4 and 6, to obtain the epoxy containing modified silica and then lowering the pH to below 4 by the addition of strong acid, for example a mineral acid such as H₂SO₄ to facilitate conversion of epoxide to diol.

For example, an aqueous mixture of the silica and epoxy silane is prepared at a pH of about 5.5 using a sodium acetate buffer or acetic acid, and then heated, for example to about 70° C. or higher, that is about 70 to 100° C., typically 70 to about 90° C., for about 0.5 to about 8 hours, typically from about 1 hour to about 6 hours to generate the epoxy substituted siloxy modified silica. The pH is then lowered to about 3.5 by the addition of H₂SO₄ and the mixture heated for an additional 0.25 to 3 hours to generate the diol.

Heating is not generally required for the periodate oxidation. Isolation of the modified silica particle can be facilitated by reducing the amount of water present by distilling or evaporation at ambient or reduced pressure.

As shown in the Examples, the order of the above transformations can be changed, for example, 3-glycidyloxypropyltrimethoxysilane can be transformed into a diol containing species by heating in water at a pH of 3.5, followed by periodate oxidation to the aldehyde before the introduction of the nano-silica.

The modified silica particles can be isolated as is by any common method such as filtration or centrifuge, or the modified particles can be purified, for example by dialysis, prior to isolation. While not necessary for many applications, purification can also occur after isolation.

The modified particles of the invention are typically from 50 to 95% by weight silica based on the weight of the particle as determined by TGA, for example from 60 to 95% or 60 to 90% by weight silica. Excellent results in polymer compositions have been obtained with particles that are about 65 to 70% silica, and with particles that are about 70 to 80% silica as well as with particles that are about 75 to about 87% silica.

The amount of organo silyl material on the surface ranges from 5 to about 50%, for example 5 to about 40%, typically between 10 and 40% by weight of the particle, for example, particles with about 30 to 35%, 20 to 30% and 13 to about 25% organosilane have been used with good success.

The simplicity of this method (one pot reaction), as well as the effective method of purification (dialysis), allows one to isolate modified silica particles of very small particle size which can improves dirt pick-up resistance performance. This is not to say that the resulting modified particles are as small as the starting nano-particles, but particle sizes of a few microns and smaller are easily obtained. For example, modified silica particles of about 2 microns or less as determined by SEM and dynamic light scattering are routinely obtained; 2 microns being the diameter of a sphere which approximates the volume of the particle. In one embodiment of the invention, the modified silica particles are 1 micron or smaller and particles less than 500 nm can be prepared, for example, particles of 40-400 nm can be prepared by the methods herein.

The particles of the invention are readily incorporated into a wide variety of naturally occurring or synthetic polymer compositions using common processing techniques. The naturally occurring or synthetic polymer, for example, may be a thermoplastic, thermoset, crosslinked or inherently crosslinked polymer, for example, a polyolefin, polyamide, polyurethane, polyacrylate, polyacrylamide, polyvinyl alcohol, polycarbonate, polystyrene, polyester, polyacetal, polysulfone, polyether, polyether ketone, cellulose ether, cellulose ester, a natural or synthetic rubber or a halogenated vinyl polymer such as PVC, alkyd resin, epoxy resin, unsaturated polyester, unsaturated polyamide, polyimide, fluorinated polymer, silicon containing polymer, carbamate polymer and copolymers and blends thereof, for example PP/EPDM, polyamide/EPDM, ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The polymer composition containing the inventive particle may be a coating which has been applied to a substrate. The coating can comprise any coating system, or even a preformed film, and includes for example, auto coatings, marine coatings, industrial coatings, powder coatings, wood coatings, coil coatings, architectural coatings, paints, inks, laminates, receiving layers for printing applications, or other protective or decorative coatings including paper and fabric treatments and coatings or films used in glazing applications.

The coating composition according to the invention can be applied to any desired organic, inorganic or composite substrate such as synthetic and natural polymers, wood, metals, glass, mineral substrates such as concrete, plaster, bricks, stones and ceramics, etc by customary methods, for example by brushing, spraying, pouring, draw down, spin coating, dipping, applying with roller or curtain coater etc; see also Ullmann's Encyclopedia of Industrial Chemistry, 5th Edition, Vol. A18, pp. 491-500.

Generally, the coating comprises a polymeric binder which can in principle be any binder customary in industry, for example those described in Ullmann's Encyclopedia of Industrial Chemistry, 5th Edition, Vol. A18, pp. 368-426, VCH, Weinheim 1991. In general, it is a film-forming binder based on a thermoplastic or thermosetting resin. Examples thereof are alkyd, acrylic, acrylamide, polyester, styrenic, phenolic, melamine, epoxy and polyurethane resins.

For example, non-limiting examples of common coating binders also include silicon containing polymers, unsaturated polyesters, unsaturated polyamides, polyimides, crosslinkable acrylic resins derived from substituted acrylic esters, e.g. from epoxy acrylates, urethane acrylates, polyester acrylates, polymers of vinyl acetate, vinyl alcohol and vinyl amine. The coating binder polymers may be co-polymers, polymer blends or composites.

The binder can be cold-curable, hot-curable or UV curable; the addition of a curing catalyst may be advantageous, and the binder may be cross-linked.

The binder may be a surface coating resin which dries in the air or hardens at room temperature. Exemplary of such binders are nitrocellulose, polyvinyl acetate, polyvinyl chloride, unsaturated polyester resins, polyacrylates, polyurethanes, epoxy resins, phenolic resins, and especially alkyd resins. The binder may also be a mixture of different surface coating resins.

Excellent results are obtained, for example, when the present modified silica particles are used in an architectural paint dried at room temperature.

One embodiment of the invention provides water based coatings containing the particles of the invention. Upon drying or curing, the coatings not only have improved dirt-resistance, anti-adhesion properties and scratch resistance, but also have excellent film surface qualities, i.e., very smooth and even, surfaces are obtained.

Aqueous coating materials, for example, include water-soluble or water-thinnable polymers or polymer dispersions. Highly polar organic film formers, such as polyvinyl alcohols, polyacrylamides, polyethylene glycols, cellulose derivatives, acrylates and polyesters with very high acid value are examples for water-soluble polymers. Water-thinnable film formers consist of relatively short-chain polymers with acid or basic groups capable of salt formation incorporated into the side chains. They are neutralized with suitable bases or acids, which evaporates during film formation leads to insoluble polymers. Examples thereof are short and medium oil carboxylic acid alkyd resins, water-thinnable melamine resins, emulsifiable epoxy resins or silicone-based emulsions. Several polymer types are used as water-dilutable film formers. Most important of these are vinyl acetate copolymers with dibutyl maleinates, vinyl esters of Versatic acids, acrylic ester acids or terpolymers with ethylene and vinyl chloride, vinyl propionates, pure acrylates consisting of polyacrylates and polymethacrylates, acrylate copolymers with styrene and styrene-butadiene copolymers. The coating material may also be a water-borne radiation-curable formulation of photopolymerisable compounds.

The silicas according to the invention have only a slight influence on the rheology of the coating system. Because the viscosity of the coating is increased only slightly, relatively large amounts of silica can be incorporated into the coating.

For example, the inventive particles can be incorporated into a coating composition, for example an aqueous coating composition which in one embodiment comprises acrylic polymers or acrylic/styrene copolymers, at from about 0.1 to about 99% often from 0.1 to about 50% by weight based on the total weight of coating solids, to provide a coating or paint which dries to leave a high quality surface with excellent appearance and dirt pick-up resistance. Excellent results are achieved, for example, using from as little as 1, 2, 3 or 5% weight percent of the inventive particles or as much as 10, 15, 20, 30 or 40 weight percent. In one embodiment, coating compositions, in particular aqueous coating compositions, containing from about 1 to about 40%, for example about 2 to about 35% or from about 2 to about 15%, of the inventive particles are provided.

The coating compositions of the invention include paints and other coatings and surface treatments and may be applied to a large number of substrates, such as wood, paper, glass, ceramic, plaster, concrete and metal, for example. In a multi-coat process the coatings may also be applied to primers, primer-surfacers or basecoats. Surprisingly, the coating compositions of the invention display very good anti-adhesion and dirt repellency properties even when cured at room temperature.

The coating compositions of the invention can be used as anti-graffiti coatings, release coatings, dirt pick-up resistant facade coatings, ice-repelling coatings, dirt-repelling machine/instrument coatings, marine coatings (anti-fouling coatings), and dirt-repelling furniture coatings and release paper coatings and the like.

The particles of the invention can also be incorporated into polymeric article such as a film, sheet, molded article, extruded workpiece, fiber, laminate, felt or woven fabric etc. For example, the particles are incorporated into a thermoplastic polymer such as, for example, a polyolefin, polyamide, polyurethane, polyacrylate, polyacrylamide, polyimide, polycarbonate, polystyrene, polyester, polyacetal, a natural or synthetic rubber or a halogenated vinyl polymer such as PVC and the like. The polymer may also be a co-polymer or polymer blend.

The particles can be incorporated into the thermoplastic polymer, in any of the concentrations listed above for coating formulations, using any of the common techniques such as blending, extrusion, coextrusion, compression molding, Brabender melt processing, film formation, injection molding, blow molding etc.

The compositions of the invention of course may also comprise other fillers and customary additives such as calcium carbonate, aluminum hydroxide, reinforcing fibers wetting agents, dispersants, defoamers, leveling agents, thickeners (rheological additives), catalysts, driers, biocides, photoinitiators, processing aids, colorants, light stabilizers, anti-oxidants, ageing inhibitors, etc.

### EXAMPLES

In the following synthetic examples, the % silica content of the final product is determined by TGA, particle size is determined by SEM and dynamic light scattering.

In select examples the modified particles are subjected to dialysis. In these examples the dialysis occurs in a CELLUSTEP T1 dialysis membrane tube (46 mm wide, approximately 45 cm long with a wall thickness of 28 μm nominal MWCO 3500) which is submerged in 4 liters of distilled water at room temperature for 4 hours.

### Preparation of Epoxy-Modified Particles

### Example 1

### Silica Particles

A 1-liter round bottom flask is charged with 150 ml of 0.1M sodium acetate buffer, pH 5.5, 50 grams of a commercially available 34% silica nanoparticle suspension in water, average particle size ˜30-35 nm and obtained at a pH of from 3-6, and 15 grams of 3-glycidoxypropyl-trimethoxysilane. The flask is rotated in a 90° C. water bath for 5 hours after which time the modified particles are isolated from the suspension by filtration and washed with 500 ml of aqueous ethanol solution (1:1) and water (1 L) to yield the product as a press-cake of approximately 17-30% solids.

### Example 2

### Silica Particles

Following the procedure of Example 1, A 1-liter r/b flask is charged with 150 ml of 0.1M sodium acetate buffer, pH 5.5, 50 grams of the same commercial silica nanoparticle suspension and 15 grams of 3-glycidoxypropyl-trimethoxysilane. The flask is rotated in a 90° C. water bath for 5 hours using roto-evaporator apparatus without a vacuum after which time vacuum is applied and the reaction mixture is concentrated up to ˜50% of the original volume and subjected to dialysis to yield the product as a storage stable milky white suspension.

### Example 3

### Silica/Alumina Particles

A 1-liter r/b flask is charged with 150 ml of 0.1M sodium acetate buffer, pH 5.5, 50 grams a commercially available ˜30% nanoparticle suspension of alumina coated silica, Al:Si ratio 9.1:1, in water, average particle size ˜12-14 nm, and 15 grams of 3-glycidoxypropyl-trimethoxysilane. The flask is then rotated in a 90° C. water bath for 5 hours and the modified particles are isolated from the suspension as in Example 1 to yield a press-cake of approximately 17-30% solids.

### Example 4

### Silica Particles

200 ml distilled water and 90 g of the commercial silica nanoparticle suspension of Example 1 are mixed and the pH is adjusted to 5.5 with acetic acid. 15 g of 3-Glycidoxypropyl-trimethoxysilane is added and the resulting mixture is stirred for 15 minutes at room temperature and then heated at 90° C. for 5 hours. The resulting cloudy white suspension is reduced in a roto-evaporator under vacuum and 48° C. water bath until the reactive mixture is concentrated up to ˜33% of the original volume. The reduced suspension is placed in a CELLUSTEP T1 dialysis membrane tube and subjected to dialysis as described above. After dialysis, the mixture is concentrated via roto-evaporation to about 50% volume to yield the product as a milky white storage stable suspension.

### Example 5

### Silica/Alumina Particles

The procedure of Example 4 is repeated using 90 grams of the commercial alumina coated silica suspension of Example 3 as the nanoparticle to yield after dialysis and volume reduction a milky white storage stable suspension.

### Preparation of Diol-Modified Particles

### Example 6

### Silica Particles

200 ml distilled water and 90 g of the commercial silica nanoparticle suspension of Example 1 are mixed and the pH is adjusted to 5.5 with acetic acid. 15 g of 3-Glycidoxypropyl-trimethoxysilane is added and the resulting mixture is stirred for 15 minutes at room temperature and then heated at 90° C. for 3 hours. The reaction mixture temperature is reduced to 30° C., the pH is adjusted to 3.5 with H₂SO₄ and the mixture is then heated for another hour at 90° C. The temperature is again lowered to 30° C., the mixture is neutralized with NaOH and the modified particles are isolated from the suspension by filtration and washed with 500 ml of aqueous ethanol solution (1:1) and water (1 L) to yield a final product a press-cake of approximately 15-30% solids.

### Example 7

### Silica Particles

The procedure of Example 6 is repeated except that the product is not isolated a press-cake by filtration. After the mixture is neutralized with NaOH, the resulting cloudy white suspension is reduced to about 33% of the original volume in a roto-evaporator under vacuum and 48° C. water bath. The reduced suspension is placed in a CELLUSTEP T1 dialysis membrane tube and subjected to dialysis as described above. After dialysis, the mixture is concentrated via roto-evaporation to about 50% volume to yield the product as a milky white storage stable suspension.

### Example 8

### Silica/Alumina Particles

The procedure of Example 7 is repeated using 90 grams of the commercial alumina coated silica suspension of Example 3 as the nanoparticle to yield after dialysis and volume reduction a milky white storage stable suspension.

### Preparation of Aldehyde-Modified Particles

### Example 9

### Silica Particles

250 ml of distilled water and 90 grams of the commercial silica nanoparticle suspension of Example 1 are mixed and the pH is adjusted to 5.5 with acetic acid. 15 g of 3-glycidoxypropyl-trimethoxysilane is added and the resulting mixture is stirred for 15 minutes at room temperature before heating to 90° C. for 3 hours. The reaction mixture temperature is reduced to 30° C., the pH is adjusted to 3.5 with H₂SO₄ and the mixture is heated for another hour at 90° C. The temperature is again lowered to 30° C. and the mixture is neutralized with NaOH after which is added 4 grams of NaIO4 and the mixture is stirred for 16 hours. The resulting cloudy white suspension is reduced in a roto-evaporator under vacuum and 48° C. water bath until the reactive mixture is concentrated to 33% of the original volume, the reduced suspension is placed in a CELLUSTEP T1 dialysis membrane tube and subjected to dialysis as described above. After dialysis, the mixture is concentrated via roto-evaporation to about 50% volume to yield the product as a transparent stable suspension.

### Example 10

### Silica Particles

250 ml distilled water and 18 g of 3-Glycidoxypropyl-trimethoxysilane are mixed, the pH is adjusted to 3.5 with H₂SO₄, the resulting mixture is heated for 2 hrs hour at 90° C. after which the temperature is lowered to 30° C. and the mixture is neutralized with NaOH. To the neutralized reaction mixture is added 4 grams of NaIO₄ and the mixture and is stirred for 16 hours at 20° C. To this is added 50 grams of the commercial silica nanoparticle suspension of Example 1 at a pH of from 3-6 is added and the mixture is stirred 3 hrs at 90° C. The resulting cloudy white suspension is concentrated to 33% of the original volume, subjected to dialysis and concentrated to about 50% volume as in Example 9 to provide the product as a transparent stable suspension.

### Example 11

### Silica/Alumina Particles

The procedure of Example 9 is repeated using 90 grams of the commercial alumina coated silica suspension of Example 3 as the nanoparticle to yield after dialysis and volume reduction a milky white storage stable suspension.

### Preparation of Comparative Epoxy-Modified Particles Synthesized in Manic Solvent

### Example 12

A 1-liter r/b flask is charged with 10 g dry silica, prepared from methanol suspension of LUDOX TM-30 by the evaporation of the solvent, in 160 ml of dry toluene. 15 grams of 3-glycidoxypropyl-trimethoxysilane is added and the reaction mixture is refluxed gently for 3 hours after which the modified silica is filtered, washed with 500 ml toluene, 250 ml tetrahydrofuran, 500 ml of methanol, and allowed to dry on the sintered glass filter overnight.

### Modified Particles in Coatings

Samples of the above modified particles are incorporated into a white pigmented water-based architectural coating test formulation based on an acrylic/styrene dispersion with the composition shown in the table below (solid content of approximately 53% by weight). The formulations are prepared by adding the components 1 through 6 in the listed order under stirring and dispersion by high speed agitator till fineness <5 μm is achieved (˜30 min at 1500 rpm) followed by adding components positions 7 through 10 under stirring (˜45 min at 1900 rpm) after which the modified silica particles in water are added (˜20 min at 1700 rpm) and finally viscosity is adjusted by adding 12 (30 min at 1800 rpm). The added amount of modified silica is calculated by solid silica on solids of coating.

| | | Wt.-% |
|---|---|---|
| 1) | Water (deion.) | 19.5 |
| 2) | DISPEX GA40 (dispersing agent) | 0.5 |
| 3) | TEGO FOAMEX 1488 (defoamer) | 0.3 |
| 4) | EFKA 2550 (defoamer) | 0.2 |
| 5) | KRONOS 2300 (titanium dioxide) | 22.0 |
| 6) | calcium carbonate | 12.0 |
| 7) | Water (deion.) | 5.5 |
| 8) | DOWANOL DPM (dipropylene glycol | 2.0 |
| | monoethylether) | |
| 9) | Octylisothiazolinone | 0.5 |
| 10) | ALBERDINGK AS 6002 * | 38.0 |
| 11) | Modified silica | X |
| 12) | NATROSOL 250 HR (thickener) | 0.5 |

* ALBERDINGK AS 6002 - fine disperse acrylic acid and styrene copolymer about 50% in water

Solids Content of the coatings is determined using a method based on DIN ISO 3251 as follows:

Approximately 1 g of sample is weighed out on an analytical balance (accuracy 1 mg) into a single-use aluminum dish (d=about 65 mm, h=about 17 mm). The product is distributed uniformly in the dish by brief swirling. The dish is stored in a drying cabinet at about 125° C. for 1 hour. After the end of the drying operation the dish is cooled to room temperature in a desiccator for 20 minutes and weighed again on the analytical balance to a precision of 1 mg. For each test it at least two determinations are carried out with the mean value reported.

Formulations of the above coating containing A) no modified silica, and with an added 10 weight %, (9.1% by weight of modified silica solids based on coatings solids), of B) epoxy modified silica prepared in water, C) epoxy modified silica prepared using organic coatings, D) diol modified silica and E) aldehyde modified silica. (Modified silicas prepared according to the above examples.) The formulations are applied by slit coater (200 μm) on white coil coat panels and dried for least three days before testing.

The formulations A, B, D and E provide even, smooth coating films with good film aspects and no noticeable particles whereas formulation C containing the comparative epoxy modified silica prepared in organic solvents according to Example 12 provides a rough film with visible particles and poor film aspect precluding dirt resistance testing with this formulation.

Dirt pick-up resistance of acceptable coatings is evaluated with black iron oxide slurry or graphite slurry. Both slurries are applied separately on the paint surface, dried for 3 hours and then washed by tap water and a cloth or sponge. The graying of the surface (dirt pick-up) was quantitatively assessed by color measurement (DL*before/after procedure). Color measurements are done with spectrophotometer and calculation of L*, a*, b*, C*, h and DL* with CGREC software according DIN 6174. Results are displayed in the table (DL* values are given without algebraic sign and are average values of three single samples).

| Formulation | Silica particles | dL(C black) | dL (Iron oxide) |
|---|---|---|---|
| A | no silica | 41.6 | 20.9 |
| D | diol modified | 32.4 | 13.1 |
| B | epoxy modified | 35.2 | 8.9 |
| E | aldehyde modified | 28.7 | 4.4 |

All modified particles provide good dirt resistance in tests using an iron oxide slurry; aldehyde modified particles give excellent dirt resistance in tests using a graphite slurry. The aldehyde modified particles give the best overall dirt resistance.

What is claimed:

1. Surface modified silica particles comprising aldehyde containing groups bound to the particle surface obtained by the reaction under acidic conditions, of
i) a nano-silica in the form of an aqueous silica dispersion having an SiO₂ content of 20% by weight or more, or mixture of silica with alumina or other inorganics, and
ii) at least one oxysilane substituted at least once on silicon by an alkyl group containing aldehyde functionality or an oxygen functionality readily converted to an aldehyde, and,
when the oxysilane is not substituted by aldehyde, conversion of the oxygen functionality to an aldehyde.

2. The surface modified silica particles according to claim 1 wherein each reaction and conversion is carried out in water.

3. The surface modified silica particles according to claim 1 obtained from a colloidally disperse silica sol having a solids content of 20% by weight or more.

4. The surface modified silica particles according to claim 1 obtained by reacting, in an acidic aqueous media, the nano-silica with an oxysilane species of the formula
(R′O)₄₋ₙSiRₙ or 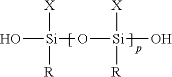
wherein
n is 1, 2 or 3; p is from 1 to about 30;
R′ is H or C₁₋₁₂ alkyl, and
R is C₁₋₆ aldehyde, C₁₋₆ alkyl substituted by hydroxyl, alkoxy, alkylcarboxy, oxirane, i.e., epoxy, or C₁₋₆ alkyl substituted by a group OR″ wherein R″ is C₂₋₆ aldehyde or C₁₋₆ alkyl substituted by hydroxyl, alkyloxy, alkylcarboxy, or oxirane and
X is hydroxy, alkoxy or a group R.

5. The surface modified silica particles according to claim 4, obtained by mixing, in an acidic aqueous media, the nano-silica with an oxysilane species of the formula (R′O)₄₋ₙSiRₙ and when the oxysilane is not substituted by aldehyde, conversion of the oxygen functionality to an aldehyde.

6. The surface modified silica particles according to claim 5, wherein the oxysilane species has the formula
(R′O)₄₋ₙSiRₙ
wherein
n is 2 or 3;
R′ is C₁₋₁₂ alkyl, and
R is

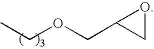

7. A composition comprising from 0.1 to 99%, by weight based on the weight of the composition of modified silica particles according to claim 1 and a natural or synthetic polymer.

8. A composition according to claim 7 which is an aqueous coating formulation and the amount of the modified silica particles is based on solids of the coating formulation.

9. A process for preparing modified silica particles which process comprises
1) mixing a silica sol or other aqueous dispersion of nano-silica particles having a SiO₂ content of 20% by weight or more, or silica mixed or coated with alumina or other inorganic, with at least one oxy silane of the formula
(R′O)₃SiR or (R′O)₂SiR₂
wherein
R′ is C₁₋₁₂ alkyl, for example C₁₋₄ alkyl and
R is 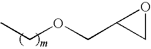
wherein m is a number from 1 to 6
in an acidic aqueous environment followed by conversion of epoxy groups to aldehyde groups.

10. A process for preparing modified silica particles according to claim 9 which process comprises:
1) mixing a silica sol or other aqueous dispersion of nano-silica particles having a SiO₂ content of 20% by weight or more, or silica mixed or coated with alumina or other inorganic, with at least one oxy silane of the formula
(R′O)₃SiR or (R′O)₂SiR₂
wherein
R′ is C₁₋₁₂ alkyl, and
R is 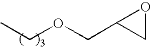
in an acidic aqueous environment followed by
2) neutralization of the acid and addition of periodate or periodic acid.

11. A process according to claim 9, wherein
the silica sol or other aqueous dispersion of nano-silica particles having a SiO₂ content of 20% by weight or more, or silica mixed or coated with alumina or other inorganic, is mixed with at least one oxy silane of the formula
(R′O)₃SiR or (R′O)₂SiR₂
in water at a pH of between 4 and 6 at a temperature of from 70 to 100° C., for a time of from 1 to 6 hrs after which the pH is lowered to below 4 and heated to a temperature of from 70 to 100° C. for 0.25 to 3 hours followed by
neutralization of the acid and addition of periodate or periodic acid.

12. A process according to claim 11 wherein
the aqueous silica sol having an SiO₂ content of >20% by weight aqueous dispersions nano-silica particles or silica mixed or coated with alumina, is mixed with at least one oxy silane of the formula
(R′O)₃SiR
in water at a pH of between 4 and 6 at a temperature of from 70 to 90° C., for a time of from 3 to 5 hrs after which the pH is lowered to 3.5 or less and heated to a temperature of from 70 to 90° C. for 1 to 2 hours followed by
neutralization of the acid and addition of periodate or periodic acid.

13. A process according to claim 11, wherein addition of periodate or periodic acid occurs at a temperature of from 0 to 20° C. and the resulting mixture is held at a temperature of from 0 to 20° C. for a time of from 10 to 16 hrs in the dark.

14. A process for preparing a modified silica particle which process comprises:
1) heating at least one oxy silane of the formula
(R′O)₃SiR or (R′O)₂SiR₂
wherein
R′ is C₁₋₁₂ alkyl, for example C₁₋₄ alkyl and
R is 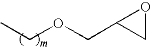
wherein m is a number from 1 to 6
in water at a pH of less than 4 at a temperature of from 70 to 100° C. for 0.25 to 3 hours followed by
2) neutralization and addition of periodate or periodic acid to form a reaction mixture which is then
3) mixed with a silica sol or other aqueous dispersion of nano-silica particles having a SiO₂ content of 20% by weight or more, or silica mixed or coated with alumina or other inorganic in water at a pH of between 4 and 6 at a temperature of from 70 to 100° C., for a time of from 1 to 6 hrs.

15. A process according to claim 14 wherein addition of periodate or periodic acid occurs at a temperature of from 0 to 20° C. and the resulting mixture is held at a temperature of from 0 to 20° C. for a time of from 10 to 16 hrs in the dark before mixing with a silica sol or other aqueous dispersion of nano-silica particles having a SiO₂ content of 20% by weight or more, or silica mixed or coated with alumina or other inorganic.

16. An aqueous coating formulation comprising from 0.1 to 99% by weight based on solids of a modified silica particle obtained by mixing a silica sol or other aqueous dispersion of nano-silica particles having a SiO₂ content of 20% by weight or more, or silica mixed or coated with alumina or other inorganic, with at least one oxy silane of the formula
(R′O)₃SiR
wherein
R′ is C₁₋₁₂ alkyl, and
R is 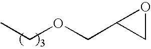
in water at a pH of between 4 and 6 at a temperature of from 70 to 100° C., for a time of from 1 to 6 hrs.

17. A method for improving dirt pick-up resistance or anti adhesion properties of paper, paperboard, wood, chipboard, plastic, synthetic fibers, natural fibers, textile fibers, textiles, leather, glass fibers, rock wool, paint coats, masonry, ceramic, metal or metal alloys by applying a composition comprising the particles of claim 1.

18. Anti-graffiti coatings, release coatings, self-cleaning facade coatings, ice-repelling coatings, car wheel coatings, dirt-repelling machine/instrument coatings, anti-fouling coatings for ships, and dirt-repelling furniture coatings or release paper coatings comprising from 0.1 to 99% by weight based on coating solids of the particles according to claim 1.
